(19) United States
(12) Patent Application Publication
(10) Pub. No.: US 2011/0258545 A1
(43) Pub. Date: Oct. 20, 2011

(54) Service for Sharing User Created Comments that Overlay and are Synchronized with Video

(75) Inventor: Jim Hunter, San Jose, CA (US)

(73) Assignee: WITSTREAMS, San Jose, CA (US)

(21) Appl. No.: 13/090,030

(22) Filed: Apr. 19, 2011

Related U.S. Application Data
(60) Provisional application No. 61/326,038, filed on Apr. 20, 2010.

(51) Int. Cl. G06F 3/00

(52) U.S. Cl. 715/716

(57) ABSTRACT

In one embodiment, a method for allowing an end user to create a comment stream synchronized to a content stream is provided. The method receives a selection of the content stream that contains video and/or audio that the end user is authorized to view. A computing device adds the comment stream composed of one or more comments that are synchronized with a timeline of the content stream without modifying the content stream. The comment stream and the content stream are stored separately. Playback of comment stream to the content stream is then synchronized.

### CROSS REFERENCE TO RELATED APPLICATIONS

The present application claims priority to U.S. Provisional App. No. 61/326,038 for “Service for Sharing User Created Graphical Comments that Overlay and Are Synchronized with Video” filed Apr. 20, 2010, the contents of which is incorporated herein by reference in their entirety.

### BACKGROUND

Particular embodiments generally relate to synchronizing user generated digital comments with video stream.

Since the rise of broadband, videos are and will continue to be a mainstay of the web. The amount of videos created and uploaded by individuals has risen dramatically as of recent due to the advances in technology, both in recording and uploading. Videos are an expression by a single user, the director. When videos are uploaded to a website, viewers view those videos. Viewers of videos can comment in blogs that are attached to a particular video. With all of the videos on the web, it is rare to find videos without comments that are more than a few weeks old. People create, view and comment on the video uploaded by others. Those comments are generally grouped with the video as a whole. Recently, popular sites have begun to extract popular parts of videos and save them separately as “clips”. This allows the viewer to comment at a more granular level, specifically on the clip. Further, messaging is and will continue to be a mainstay of the web. Users of the web communicate with each other in real time with others around the world. Some users even watch video together in different locations, and comment via messaging on the video they are sharing. Comments in instant messaging tend to have a context to them. That context may be regarding comments they receive, or events in time. History of the comments can be retrieved by some messaging software, and the context of other comments make the flow of instant messaging read like a conversation. However, other contexts are potentially lost in this history.

The process of overlaying graphic elements over live video has been conventionally done. A “Pop Up Video” had pop up graphics applied to a broadcast video that were integrated into the original content. This altered the original content stream and resulted in as single stream. This required access to the original content stream, and required the owner of the content stream to alter the content in a postproduction stage. Later, networks began to overlay their channel information and after that advertisements over the original video. All of this content was under the direction of large corporations and broadcast to the consumers of the video. The original editors and authors inserted comments that were directly injected into the audio/video content.

### SUMMARY

In one embodiment, a method for allowing an end user to create a comment stream synchronized to a content stream is provided. The method receives a selection of the content stream that contains video and/or audio that the end user is authorized to view. A computing device adds the comment stream composed of one or more comments that are synchronized with a timeline of the content stream without modifying the content stream. The comment stream and the content stream are stored separately. Playback of comment stream to the content stream is then synchronized.

In one embodiment, a method for playing a user created comment stream synchronized to a content stream is provided. The method includes: receiving a selection of a content stream that contains video and/or audio; receiving a selection of a comment stream that was generated by an end user for the selected content stream, wherein the comment stream and the content stream are separately stored; generating comment items for the comment stream at specific times in a timeline; and playing back the content stream while overlaying the comment items for the comment stream at the specific times.

In one embodiment, an apparatus for allowing an end user to create a comment stream synchronized to a content stream is provided. The apparatus includes: one or more computer processors; and a computer-readable storage medium comprising instructions for controlling the one or more computer processors to be operable to: receive a selection of the content stream that contains video and/or audio that the end user is authorized to view; add the comment stream composed of one or more comments that are synchronized with a timeline of the content stream without modifying the content stream, wherein the comment stream and the content stream are stored separately; and synchronize playback of comment stream to the content stream.

The following detailed description and accompanying drawings provide a better understanding of the nature and advantages of the present invention.

### BRIEF DESCRIPTION OF THE DRAWINGS

FIG. 1 shows the separated content and comment streams according to one embodiment.

FIG. 2 shows combined stream from FIG. 1 with a comment stream overlaid on top of content stream 101 according to one embodiment.

FIG. 3 shows the flow pattern for an authoring user to create a comment according to one embodiment.

FIG. 4A-D shows the flow pattern for the user finding comment streams for a given content stream according to one embodiment.

FIG. 5 shows the flow for viewing one or more comment streams for a given content stream according to one embodiment.

FIG. 6 shows the flow of data in the system for selecting one content stream and viewing one comment stream for that content stream according to one embodiment.

FIG. 7 illustrates an example of a special purpose computer system configured with a comment editing system according to one embodiment.

### DETAILED DESCRIPTION

Described herein are techniques for a comment sharing system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

Particular embodiments generally relate to allowing users to create/make comments that apply to a given timeline position, and thus the context of a video frame on which the comments are synchronized with may be altered upon playback. User defined graphical elements of a comment stream may be generated and overlaid on a content stream using four dimensions of the content stream, which are the x, y, z & time axes.

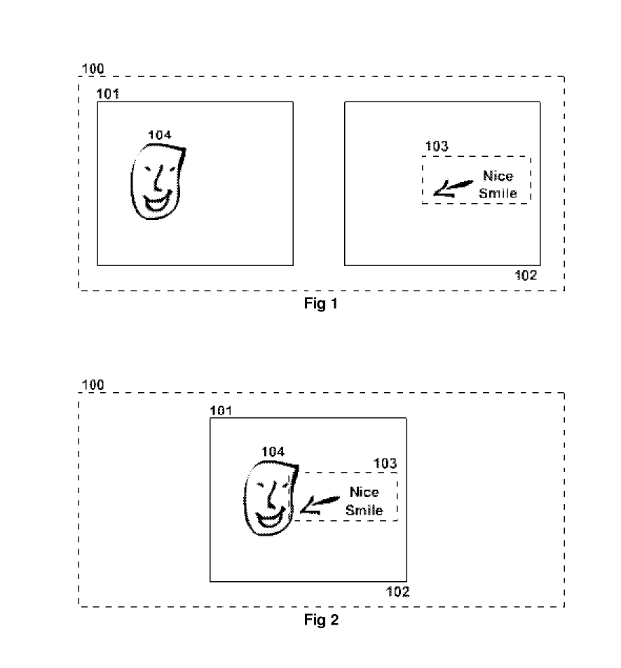

FIG. 1 shows a separated content stream 101 and a comment stream 102 according to one embodiment. A combined stream 100 is composed of content stream 101 and comment stream 102. Comment stream 102 contains a comment 103 that is directed to content stream 101.

In the embodiment represented in FIG. 1, comment 103 is comprised of a graphical element with text (e.g., an arrow and “Nice Smile”). The user can set the placement of the element by using drag and drop techniques to set the x, y, and z positions. The term comments generally refers to any user generated elements that are synchronized with content 101. Comments may include those that are graphical in nature, such as text or images. Also, comments may include interactive touch points, such as buttons, that are hyper navigational or invoke action and respond to gestures such as mouse clicks, pinch, flick and mouse drag and drops. Comments may include audio playback capabilities. Comments that contain audio may start/stop based on position as well as modify content playback controls to enable comment audio to play at an audible level relative to possible content audio. Comments may include video playback capabilities. Comments that contain video may start/stop based on position as well as modify content playback controls, sizing & placement to emphasis video comment over content video.

Comments may include control signals that change real devices in and around the area the content and comments are played back. Comments may be dynamic in nature. Factors not realized until content playback can shape any parameter of the dynamic comment. Further, a dynamic comment may be different every time the content is played back as the factors that modify the dynamic comment parameters can changed based on instantaneously available information.

Comments are created by the user via a user interface. The user employs simple gestures to appropriate the comments into the comment stream. For example, comments may be dragged and dropped into the comment stream. Once in the comment stream 102, the user can adjust the x, y, z and time line positions of the comment. Additionally the user can set specific parameters for the comment as is necessary.

The timeline position of the element in comment 103 is set by default to a point in the timeline the content stream 101 was positioned when the gesture to add the element was performed. The term content or primary content generally refers to the content to which the user generated comments are synchronized. Specific element parameters may then be received from the user, including the text “Nice Smile”.

FIG. 2 shows combined stream 100 from FIG. 1 with comment stream 102 overlaid on top of content stream 101 according to one embodiment. Comment 103 is positioned so as to comment specifically on content 104 of the comment stream 101. This is accomplished by setting the x, y and z coordinates of comment 103 specifically. As well, comment 103 is placed in the timeline of the comment stream 102 so that it provides commentary specifically on content 104.

Comments can be applied to a content stream without regards to the time line. This comment can be employed for communication via real time messages to the comment stream via an authorized user or service. This allows broadcast comments to be sent at any point during the timeline in real time. Broadcast comments are displayed uniformly to any users viewing a comment stream. Any comment can be broadcast using this mechanism.

Comments are played back overlaid on top of the primary content, and synchronized with the primary content. Transport functions performed on the playback control such as pause, play, stop and timeline navigation control both the primary content and comment stream. The comment stream and primary content remain synchronized.

While viewing a particular content stream, users can change the comment stream they are viewing. The comment stream is to be thought of as an independent media “channel” synchronized to the content stream. If the user encounters a spot of interest in the content stream, and the content stream is either paused or in motion, the user can change between multiple comment streams without disturbing the underlying content stream playback.

The comment stream can be edited by the user on the fly. When a viewer is open and watching a comment stream, changes made on the particular comment stream by the user, will be updated automatically to viewers of the same comment stream. For example, a user creates a comment stream for a particular content stream and posts it. Several of the user's friends choose to view the comment stream. At a given moment, the user decides to add a video comment from his webcam into the existing comment stream currently being viewed at a given point in the content timeline. Viewers with active subscriptions (open comment streams) that are currently viewing ahead or at the point in the video timeline of the new video comment will see the widget, as it will be sent to all open comment streams that are subscribing to the original comment stream.

In some embodiments elements used to create comments may be free while others may cost the user who creates them a fee. Viewers of the combined stream of comments and content will see the comment element in a read only mode for no charge. The user would be granted the right to include the comment element based upon time and number of use parameters, which could be without set to unlimited.

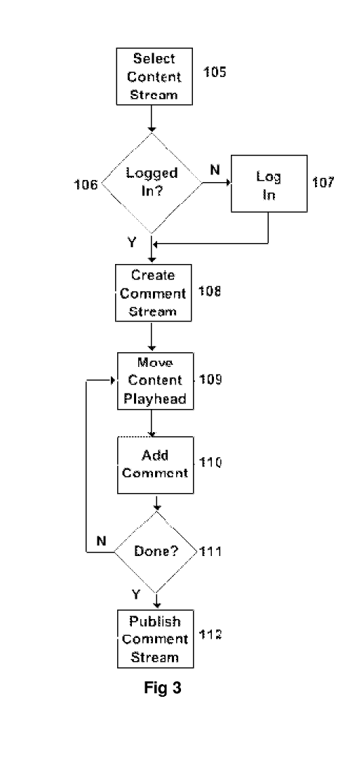

FIG. 3 shows a flowchart for creating a comment according to one embodiment. At 105, a selection from a user selecting the content that the user wishes to view is received.

A test is performed to see if the user is logged in at 106. If the user is not logged in, the user may be required to login at 107 to an active account to have rights to editing comment streams. The user only may edit comment streams they are authenticated to edit. Once the user is logged in, the user chooses to create a comment stream at 108 on the selected content. Creating the comment stream at 108 opens an editor with the known assets for the particular logged in user.

The user finds a position in the content the user wishes to add a comment by using play head transport controls of the editor at 109. The transport controls include navigational controls, such as play, forward, rewind, stop, etc. A comment is received from the user at 110 by an input mechanism. An example for one embodiment is that the user right clicks on the editor at an x, y, z position that comment is to be added. The user selects the parameters specific to a particular comment including any position, duration, text, graphic, video, audio, animation, control or other parameter for the comment.

Once the parameters are chosen and comment is set, the user decides at 111 whether or not to add another comment to another point in the timeline. If the user does, then the play head is moved again at 109 and another comment is received at 110. Once all comments are completed, the user can choose to finish the creation by publishing the comment stream at 112. This causes all opened comment streams of the same source to update themselves, and also makes the comment stream available to authorized searches for comment streams on the content used.

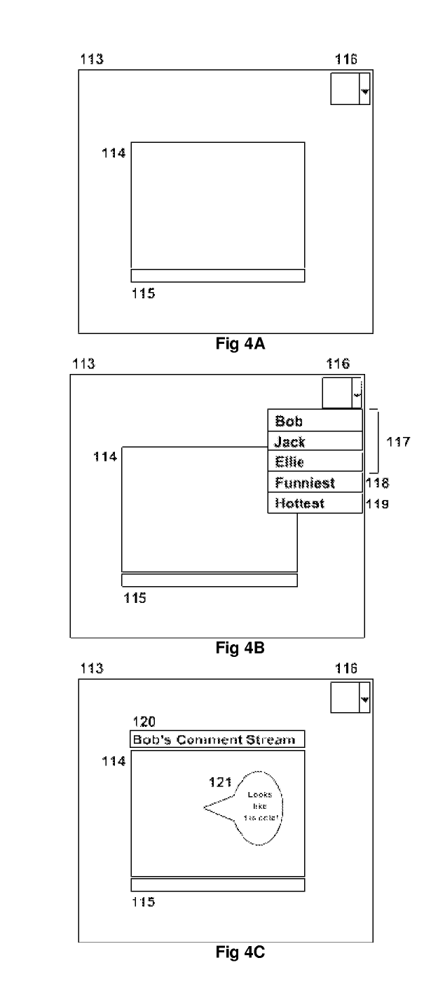

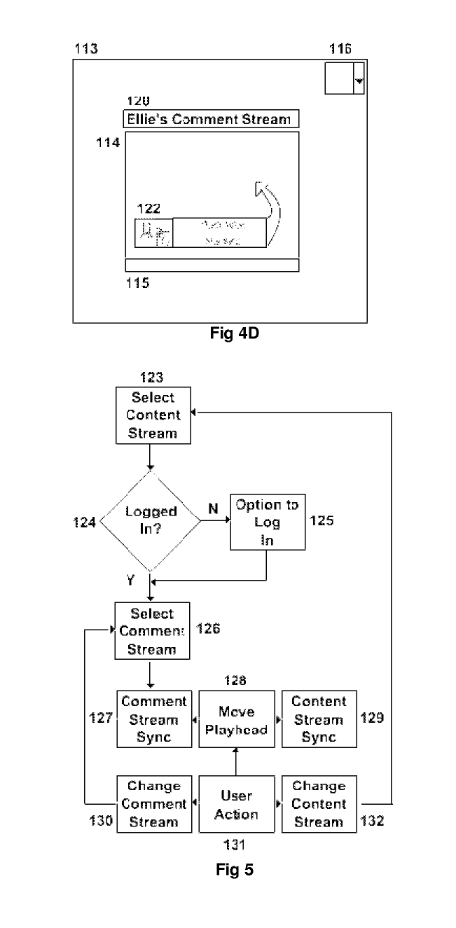

FIG. 4A-D shows a user interface 113 for viewing comment streams synchronized with content streams according to one embodiment. The comment stream is overlaid on the content stream in a viewer 114. A single timeline transport control 115 controls both streams. There is a content stream chosen and loaded in viewer 114 in this example. There is a selector 116 to choose comment streams for the chosen content stream.

FIG. 4B shows the result of making a selection using selector 116 in one embodiment. A pull down menu displays options for different types of comment streams.

The first is the list of friends comment streams 117. In this, three friends who are known by the user that have comment streams on the chosen content are listed. Additionally there is an option to choose the Funniest 118, as determined by a voting mechanism. There is also an option to choose the Hottest 119, as determined by most viewed.

FIG. 4C shows the result of selecting from the friend list 117 entry Bob. For the given timeline position 115 of the viewer 114, Bob's comment stream; as indicated by the label 120, has a comment 121 with a specific position, and text. Note that the comment 121 also points to a specific area of the content.

FIG. 4D shows the result of selecting from the friend list 117 entry Ellie. The underlying content in the viewer 114 does not change, nor does the timeline position 115, regardless of whether the content is playing or paused. Note the Ellie's comment 122 has a completely different style, text, graphics, position and pointer. In one embodiment, each comment stream is independent and the only thing the comments streams have in common in this case, is the comment streams apply to the same content stream.

FIG. 5 shows the flow for viewing one or more comment stream for a given content stream according to one embodiment. First, a selection from a user selecting the content is received at 123 that the user wishes to view.

A test is performed to see if the user is logged in at 124. If the user is not logged in, the user can login at 125 to see specific preferences of the user, but is not required. Which comment stream to view is received at 126 for the selected content. This loads the comment stream into the viewer and synchronizes the comment stream at 127 with the content stream time line position at 128. For example, the comments in the comment stream are synchronized at different time line positions in the content stream.

In one embodiment, the comment stream may be a script that generates comments based on commands synced to the content stream timeline. For example, a command may indicate to the comment stream that an identified comment should be generated at a certain time. The comment is generated and overlaid on the content stream. For example, the comments in the comment stream are dynamically generated graphic elements that are created/destroyed/changed based on the script. In this way, the comment stream is different from a second audio/video stream that is played together with the comment stream and overlaid on the content stream. However, a second audio/video stream may be used.

The change of comment streams versus the change of content streams will now be described. For example, if the user action at 131 is to change the comment stream at 130, the process returns to 126 to select the new comment stream, which synchronizes with the time line position of the content stream, regardless of whether the content stream is playing or paused.

In contrast, if the user action at 131 is to change the content stream at 132, the entire flow repeats as new content is selected at 123. This is because the change of content invalidates the chosen comment streams, the list of comment streams and possible search results. In this case, all comment streams apply to a specific content stream. Further, comment streams are specific to a single author. Once deployed, comment streams may be changed at the author's whim A subscription mechanism allows all comment streams to update on the fly if the source comment stream is modified by the author.

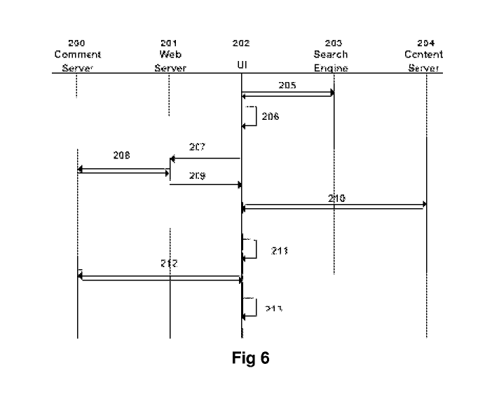

FIG. 6 shows the flow of data in the system for selecting one content stream and viewing one comment stream for that content stream according to one embodiment. A user interface (UI) 202 contacts a search engine 203 and makes a request for which UI 202 receives a response 205 with a list of content according to a particular search entered into the UI 202.

UI 202 allows the user to choose the desired content at 206 from the result list. Once chosen, UI 202 connects to a web server 201 that is hosting the comment stream/content stream player. It passes a request at 208 to a comment server 200 to retrieve the list of comment streams available for the chosen content stream at 208. Web server 201 returns a composite webpage at 209 to UI 202 with a player and a list of comment streams available.

When the player loads UI 202, UI 202 connects to the particular content server 204 of the selected content stream and caches the stream into the player. A selection of the comment stream is received at 211 from the list of comment streams on the web page using UI 202. The viewer connects to the comment server and retrieves the selected comment stream at 212 and overlays the comment stream on top of the comment stream in the player.

In this case, the content stream and the comment stream are stored on different servers. In other embodiments, the content stream and the comment stream are stored separately, but may be on the same storage device. The comment stream and the content stream being stored separately allows a user to use UI 202 to add/view/edit/delete comments for a content stream. The user does not need to add the comments during production of the content and also the comments are not added in the content. Also, the user does not need to be an owner of the content and have access to the content. Further, multiple users may comment on a content stream. This may cause multiple comment streams to be generated and stored separately from the content stream.

The synchronization is performed using saved time lines for the comment stream to overlay the comment stream on the content stream. As mentioned above, the comment stream may not be a second audio/video stream. Rather, the comment stream is a script that generates comments based on a timeline. This allows multiple users to generate comments for a content stream.

The user manipulates the player at 213 and moves the frame position of the content stream and the comment stream at the same time and keeps them synchronized.

A variety of hardware types and screen sizes can be used to create comment streams. Comments can be created on entirely different devices from that where the content stream is viewed. Time is the synchronizing factor for comment/content overlays. For example, while watching a content stream on a larger screen (such as pc or tv), a user can capture an image of themselves on their mobile device to be used as a comment. The time that the image is taken is compared to the frame that the video was on at the same time. A comment is added to the comment stream that contains the image from the mobile device and any additional descriptors the creator of the comment chooses to add.

Comment streams created by users are easy to manage. A user has the ability to associate any number of email accounts to their account. For security, users must verify each email by responding to an automatically generated verification email prior to seeing comment streams associated with that email.

Comment streams can be seeded to fill the void of between no comment content and large comment content. This is done by creating starting comment streams from video comments found on the web. Specifically, when a video URL is loaded as the content for the player the associated text only comments found on the page of the video are turned into a comment stream and associated to the email or alias associated with the author of the text only comment.

In some embodiments the comment stream is manifested as a video itself. In these cases, the comment stream script is rendered into a video comment stream at the time of authorship. Rather than existing as simply a script that is rendered “on the fly”, the comment stream can exist as a transparent overlay video. This allows a greater stability, and more accurate playback. It does however slow the authorship time to publish. However, even as a separate video overlay, the comment stream at no time modifies the original content stream.

In some embodiments the comment streams are not confined to the web. Television and PVR type devices are other targets on which the comment streams could run. Any video, live or recorded, is a potential source for comment streams.

In some embodiments, neither the authoring nor the playback of comment streams is confined to the device on which the content stream is viewed. A personal or mobile device can be used to create comments in a comment stream, adjust their settings and upload them. For example, when watching a television show, the user may want to make some comments about the content. A mobile phone has text, audio, image, and even video capture capability. A user could use such a mobile phone to capture comment streams based on a nearby content playing, and apply it to the timeline of that content. It could even store that comment stream on a remote location and associate to the content automatically. By the same measure, a user could view a comment stream on their mobile phone while the content stream is playing on the another device, like a television.

In some embodiments, the viewing of the comment stream can follow the following flow. The viewer selects an episode of a broadcast program can be chosen as the content stream. Lists of known/preferred comment stream creators who have comment streams for the program are listed in an easily navigable list. The viewer can select a comment stream to view while watching the program. While the program is paused or in motion, the viewer can opt to jump between comment streams and see different comments around a certain spot of interest within the program.

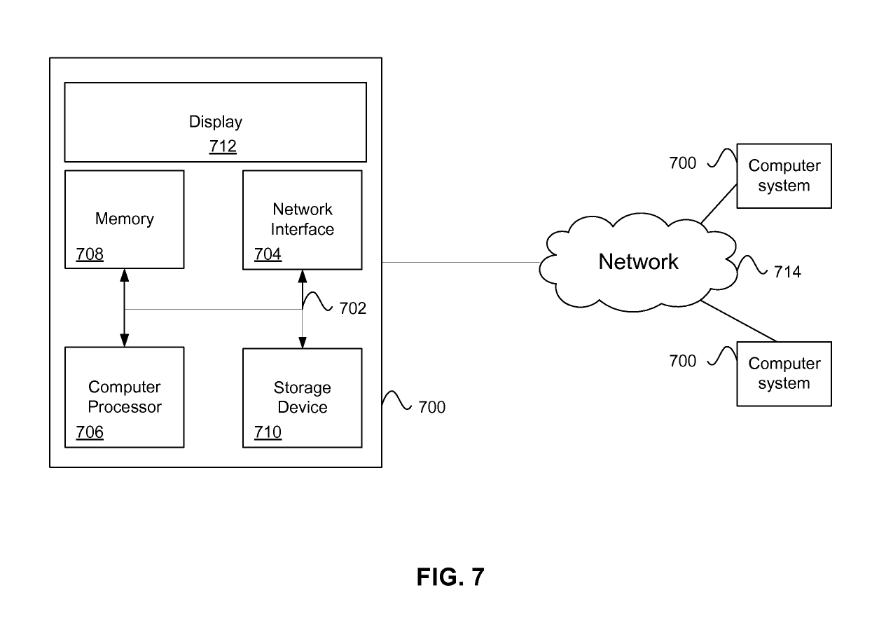

FIG. 7 illustrates an example of a special purpose computer system 700 configured with a comment editing system according to one embodiment. Computer system 700 includes a bus 702, network interface 704, a computer processor 706, a memory 708, a storage device 710, and a display 712.

Bus 702 may be a communication mechanism for communicating information. Computer processor 704 may execute computer programs stored in memory 708 or storage device 708. Any suitable programming language can be used to implement the routines of particular embodiments including C, C++, Java, assembly language, etc. Different programming techniques can be employed such as procedural or object oriented. The routines can execute on a single computer system 700 or multiple computer systems 700. Further, multiple processors 706 may be used.

Memory 708 may store instructions, such as source code or binary code, for performing the techniques described above. Memory 708 may also be used for storing variables or other intermediate information during execution of instructions to be executed by processor 706. Examples of memory 708 include random access memory (RAM), read only memory (ROM), or both.

Storage device 710 may also store instructions, such as source code or binary code, for performing the techniques described above. Storage device 710 may additionally store data used and manipulated by computer processor 706. For example, storage device 710 may be a database that is accessed by computer system 700. Other examples of storage device 710 include random access memory (RAM), read only memory (ROM), a hard drive, a magnetic disk, an optical disk, a CD-ROM, a DVD, a flash memory, a USB memory card, or any other medium from which a computer can read.

Memory 708 or storage device 710 may be an example of a non-transitory computer-readable storage medium for use by or in connection with computer system 700. The computer-readable storage medium contains instructions for controlling a computer system to be operable to perform functions described by particular embodiments. The instructions, when executed by one or more computer processors, may be operable to perform that which is described in particular embodiments.

Computer system 700 includes a display 712 for displaying information to a computer user. Display 712 may display a user interface used by a user to interact with computer system 700.

Computer system 700 also includes a network interface 704 to provide data communication connection over a network, such as a local area network (LAN) or wide area network (WAN). Wireless networks may also be used. In any such implementation, network interface 704 sends and receives electrical, electromagnetic, or optical signals that carry digital data streams representing various types of information.

Computer system 700 can send and receive information through network interface 704 across a network 714, which may be an Intranet or the Internet. Computer system 700 may interact with other computer systems 700 through network 714. In some examples, client-server communications occur through network 714. Also, implementations of particular embodiments may be distributed across computer systems 700 through network 714.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method for allowing an end user to create a comment stream synchronized to a content stream, the method comprising:
receiving a selection of the content stream that contains video and/or audio that the end user is authorized to view;
adding, by a computing device, the comment stream composed of one or more comments that are synchronized with a timeline of the content stream without modifying the content stream, wherein the comment stream and the content stream are stored separately; and
synchronizing playback of comment stream to the content stream.

2. The method of claim 1, wherein a comment in the comment stream is text, graphical, audio, or video.

3. The method of claim 2, wherein when the audio is played back when synchronized with the content, audio properties of the content stream are manipulated to emphasis the audio of the comment.

4. The method of claim 2, wherein when video is played back when synchronized with the content, video properties of the content stream are manipulated to emphasis the video of the comment.

5. The method of claim 1, wherein a comment in the comment stream includes control signals, the control signals indicating when the comment should be generated and displayed in the content stream.

6. The method of claim 1, wherein the comment stream is overlaid on top of the content stream and positioned on the x, y, and z axes relative to the content stream for a given frame in the timeline.

7. The method of claim 1, further comprising rendering one or more comment streams in one or more devices different than a playback location of the content stream.

8. The method of claim 1, further comprising:
storing the comment stream in a first storage area; and
storing the content stream in a second storage area, wherein the comment stream and the content stream are retrieved from the first storage area and the second storage area for synchronization.

9. The method of claim 1, further comprising:
receiving a comment for the comment stream; and
determining a time on the timeline;
storing the comment and the time in the comment stream, wherein the time is used to add the comment to the content stream during playback.

10. The method of claim 1, further comprising:
outputting a user interface;
receiving a selection of the comment stream in the user interface;
receiving a selection of the content stream in the user interface; and
retrieving the comment stream and the content stream from separate storage devices for synchronization and playback.

11. The method of claim 1, wherein the comment stream comprises a first comment stream, the method further comprising:
receiving a selection of a second comment stream in the user interface;
retrieving the second comment stream; and
synchronizing and playing back the second comment stream and the content stream in the user interface.

12. The method of claim 1, wherein the comment stream comprises a script, the method further comprising:
determining a time to generate a comment with respect to the timeline of the content stream;
generating the comment; and
displaying the comment overlaid at a time with the content stream.

13. A method for playing a user created comment stream synchronized to a content stream, the method comprising:
receiving a selection of a content stream that contains video and/or audio;
receiving a selection of a comment stream that was generated by an end user for the selected content stream, wherein the comment stream and the content stream are separately stored;
generating comment items for the comment stream at specific times in a timeline; and
playing back the content stream while overlaying the comment items for the comment stream at the specific times.

14. The method of claim 13, wherein the comment stream is rendered on a same device upon which the content stream is rendered and the comment stream is overlaid on top of the content stream graphically.

15. The method of claim 13, wherein the comment stream is rendered on a same device upon which the content stream is rendered and the comment stream is rendered in a separate graphical area than the area where the content stream is rendered.

16. The method of claim 13, wherein the comment stream is rendered on a device different than a device on which the content stream is rendered.

17. The method of claim 13, wherein multiple comment streams from separate sources are rendered on separate devices and are chosen on each device that the comment streams are rendered upon.

18. The method of claim 13, further comprising:
receiving another selection of another comment stream;
generating comment items for the another comment stream at specific times in the timeline; and
playing back the content stream while overlaying the comment items for the another comment stream at the specific times.

19. An apparatus for allowing an end user to create a comment stream synchronized to a content stream, the apparatus comprising:
one or more computer processors; and
a computer-readable storage medium comprising instructions for controlling the one or more computer processors to be operable to:
receive a selection of the content stream that contains video and/or audio that the end user is authorized to view;
add the comment stream composed of one or more comments that are synchronized with a timeline of the content stream without modifying the content stream, wherein the comment stream and the content stream are stored separately; and
synchronize playback of comment stream to the content stream.

20. The apparatus of claim 19, wherein a comment in the comment stream is text, graphical, audio, or video.
